(19) United States
(12) Patent Application Publication
(10) Pub. No.: US 2008/0176096 A1
(43) Pub. Date: Jul. 24, 2008

(54) Solderable layer and a method for manufacturing the same

(76) Inventor: Yen-Hang Cheng, Tun-Cherng City (TW)

Correspondence Address: ANDREWS KURTH LLP, 1350 I STREET, N.W., SUITE 1100, WASHINGTON, DC, 20005, US

(21) Appl. No.: 11/655,835

(22) Filed: Jan. 22, 2007

(51) Int. Cl. B32B 33/00; B05D 5/12

(52) U.S. Cl. 428/624; 427/99.2

(57) ABSTRACT

A solderable layer has an organic buffer film (OBF) and an immersion tin coating deposited on a substrate. The OBF is first coated on the surface of the substrate to modify the surface of the substrate and having fluorocarbon-based polymers (solution type). The immersion plating solution pass through the OBF and the immersion tin coating is then coated on the substrate. A method to manufacture the solderable layer according to any one of claims 1 to 12 has following steps of (1) coating an organic buffer film (OBF) on a surface of a substrate to form a modified surface, (2) drying the modified surface, (3) applying the substrate into a solution with immersed tin compositions to allow the immersed tin to deposit on the modified surface, (4) rinsing the modified surface with water and (5) drying the substrate.

### BACKGROUND OF THE INVENTION

1. Field of Invention

The present invention relates to a solderable layer and a method for manufacturing the same, and more particularly to a solderable layer including an organic buffer film and an immersed-tin layer on a substrate and a method for manufacturing the solderable layer. The solderable layer has a steady solderability and eliminates tin whiskers from forming on a surface of the immersed-tin layer.

2. Description of the Related Art

Circuit boards, such as printed circuited board (PCB) are generally fabricated in a surface-finished condition by board manufacturers and are shipped to an assembly house. Some circuitry is left exposed for later soldering and hence the exposed circuitry must retain a good solderability. The exposed circuitry is composed of copper or copper alloys. However, copper or copper alloys are unstable and easily react with oxygen to form oxides. Moreover, the formation of oxides can degrade its solderability. Therefore, a surface of the exposed circuitry has to be finished to prevent the solderability of the exposed circuitry.

The exposed circuitries have previously been electrodeposited a tin or tin alloys on the surface to preserve solderability. However, tin whiskers were found to form on the surface of the electrodeposited tin layer. A tin alloy finish, hot-air solder leveling (HASL), has been used extensively as the final finish for exposed circuitry on circuit boards. However, the HASL that plates tin and lead on the circuit board will result in environment problems. Other than the planarity issue, surface finishes are serving different functions other than soldering. Wire bonding, contacting surfaces and compression connections applications require alternate HASL finishes. Immersion tin was reintroduced to the market within the past decade. The immersion tin coating on the circuitries was used to substitute the HASL surface finish in some applications, to preserve the solderability of the exposed circuitry and to keep the solderability of the exposed circuitry for a long time. A thickness of the immersion tin coatings is about 0.8˜2 μm and has been common belief that the thin layer of immersion tin coating is non-whiskering. However, tin whiskers were found to grow on the surface of immersion tin coatings. These whiskers could fall on any part of the circuit boards and cause serious reliability risks. Therefore, a method to reduce a formation of tin whiskers was needed.

At the start of immersion tin deposited time, Cu—Sn intermetallic phase was initially formed followed by the pure tin layer. FIG. 5 depicts the cross-section of the immersion tin coating layer deposited at 70° C. for 15 min was prepared by FIB etching. The region at the bottom is copper, and above the copper substrate, a layer of IMC was observed. The thickness of the immersion tin coating was affected by the roughness of the copper surface. The thickness of tin layer is about 0.5˜1.5 μm and the thickness of Cu₆Sn₅ layer is about 0.13˜0.6 μm. The Cu₆Sn₅ layer which had been grown irregularly, especially on the surface that is uneven and was found decrease the volume of pure tin layer and generated the compressive stress. It was also found that the roughness and smoothness of the copper surface could affect the uniformity of IMC layer in the immersion tin coatings deposited from the stannous sulfate-based baths. Compressive stress is one of the root causes for the formation of tin whiskers and is caused by the irregular formation of IMCs. Moreover, many structural defects are produced in the coating layer. When the stress is sufficiently high, tin whiskers will be formed due to such defects, and will release stress. Therefore, to reduce the irregular formation of the Cu₆Sns layer could reduce the formation of tin whiskers and a smooth copper surface was preferred.

The surface components of the coating were measured by XRD. According to the XRD patterns shown in FIGS. 6 and 7, the major component of the IMC layer is Cu₆Sn₅ and the IMC layer was covered by the pure tin layer in 10 min. FIG. 8 shows an XPS depth profile of the immersion tin coating layer obtained from the stannous sulfate-based bath by deposition at 70° C. for 15 min. The tin-rich area containing oxygen near the surface is due to the formation of stannous oxide during storage. In the bulk of the coating, both copper and tin existed. The concentration of tin was found to decrease from the coating surface to the copper substrate and the concentration of copper was found to increase from the coating surface to the copper substrate. Therefore, the tin-rich and copper-rich environment were formed in the coating structure. According to the copper-tin phase diagram, two IMCs, Cu₆Sn₅ and Cu₃Sn, can exist at the temperatures below 100° C. As shown in FIGS. 6 only peaks of Cu₆Sn₅ were observed but the peaks of Cu₃Sn were not observed. However, Cu₆Sn₅ and Cu₃Sn are known to interchange with one another. The dominant factor determining the interchange process is the dynamic equilibrium of the local concentrations of copper and tin. This means that Cu₃Sn is formed in the copper-rich area, while Cu₆Sn₅ is formed in the tin-rich area. The concentration of tin was relatively high within the immersion coating layer. Thus, a tin-rich environment was formed and this condition was conducive for the formation of Cu₆Sn₅; hence, Cu₆Sn₅ was the primary component of the IMC layer. Moreover, the content of tin in the IMC layer close to the copper substrate decreased, which in turn favored the formation of Cu₃Sn. The concentration of copper was much higher than that of tin at the Cu/IMC interface. Therefore, a layer of Cu₃Sn with a thickness of a few nanometers was predicted to exist. Moreover, excess amount of IMC can degrade the solderability of immersion tin coatings.

Immersion tin coatings could improve the soliderability of the exposed circuitry. When the immersion tin coatings were deposited on the surface of the exposed circuitry, the soliderability of the circuitries in circuit boards could be improved and preserved longer time. However, copper will rapidly diffuse into the deposited layer to react with tin and form intermetallic compounds (IMC) such as Sn₆Cu₅ and Cu₃Sn. The irregular formation of IMCs generate a compressive stress in the immersion tin coating and cause the formation of tin whiskers on the surface of the deposited layer. The excessive growth of IMCs will decrease the solderability of the immersion-deposited layer. Moreover, the tin in the pure tin layer could react with copper diffused from circuitries to form Cu₆Sn₅ and this reaction will continue during storage. Therefore, the formation of IMCs could continue and the solderability will be degraded over time.

In addition, compressive stress is caused by irregular growth of IMC, the formation of which is in turn aggravated by the diffusion of copper from substrates into the immersion tin coating. The generation of compressive stress should therefore be reduced by inserting a barrier layer to reduce the diffusion of copper. Metals (EX: Ni, Ag) can be used to be the barrier layer. However, the reliability of the metal chosen and IMCs of copper and the metal would need to be established over a long period of time. The use of an stable organic film as a barrier could be a simpler alternative, and has therefore been used in this invention. When coated onto the surface of copper substrates, OBF can reduce the diffusion rate of copper and tin. Therefore, the amount of copper diffusion into the immersion tin coating is diminished and the rate of IMC formation is reduced.

To overcome the tin whiskering, and improve the soliderability, the present invention provides a solderable layer and a method for manufacturing the same to mitigate or obviate the aforementioned.

### SUMMARY OF THE INVENTION

The primary objectives of the present invention are to provide a solderable layer including an organic buffer film (OBF) and an immersion tin coating on a substrate and a method for manufacturing the solderable layer.

To achieve the objectives, a solderable layer in accordance with the present invention has a substrate, an organic buffer film (OBF) and an immersion-deposited layer. The substrate could be printed circuited boards. The OBF is coated on a surface of circuit boards and it comprises fluorocarbon-based polymers. The immersion tin coating is then deposited over the OBF modified metal surface. A method to manufacture the solderable layer has following steps of (1) coating an organic buffer film (OBF) on a surface of a substrate to form a modified copper surface and the surface of the solder mask is also protected, (2) drying the modified surface, (3) applying the substrate into a reaction bath with compositions to allow the tin to deposit on the modified surface, (4) rinsing the modified surface with water and (5) drying the substrate.

The OBF can reduce diffusion of copper from the substrates into the immersion-deposited layer. Diffused copper and tin are the materials for a formation of IMC. Therefore, a reduce of copper diffusion can reduce a formation rate of the IMCs. Thus, the immersion tin coating of the present invention has a more steady solderability than a conventional immersion tin coating without OBF.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of the solderable layer in accordance with the present invention;

FIG. 2 is SEM images of a cross-sectioned view of a coating structure of the solderable layer in FIG. 1 prepared by FIB etching, wherein an immersion tin coating deposited on copper pad with OBF pre-coated at 70° C. for 15 minutes;

FIG. 3A is a schematic representation of a structure of the solderable layer in accordance with the present invention showing an immersion tin on copper without OBF precoated;

FIG. 3B is a schematic representation of a structure of the solderable layer in accordance with the present invention showing an immersion tin on copper with OBF precoated;

FIG. 4A is XPS depth profiles of the solderable layer in FIG. 1 with the immersion tin coating deposited on copper pad without OBF precoated (this sample is stored at room temperature for 90 days);

FIG. 4B is XPS depth profiles of the solderable layer in FIG. 1 with the immersion tin coating deposited on copper pad with OBF precoated for 10 mins at 60° C. (this sample is stored at room temperature for 90 days);

FIG. 5 is a SEM image of a cross-sectioned view of a conventional solderable layer in prior art prepared by FIB etching, wherein immersion tin coating was deposited at 70° C. for 15 minutes. (A)as-deposited;

FIG. 6 is a XRD pattern of the conventional solderable layer in FIG. 5 with immersion tin coatings deposited on the copper pads at 60° C. for 1 time;

FIG. 7 is a XRD pattern of the conventional solderable layer in FIG. 5 with immersion tin coatings deposited on the copper pads at 60° C. for 10 time; and

FIG. 8 is an another SEM image of a cross-sectioned view of a conventional solderable layer in prior art prepared by FIB etching with an immersion tin coating was deposited at 70° C. for 15 minutes (this sample is stored at room temperature for 90 days).

### DETAILED DESCRIPTION OF THE INVENTION

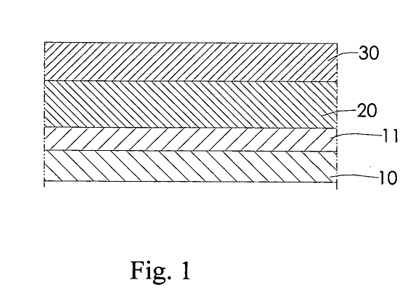

With reference to FIG. 1, a solderable layer in accordance with the present invention has a substrate (10), an organic buffer film (20) and an immersed tin layer (30).

The substrate (10) may be a printed circuit board (PCB) and has a copper surface surrounded by solder mask. The surface of the PCB has a metal circuitry (11) and a surface. The circuitry (11) is mounted on the surface of the PCB and may be composed of copper or copper alloys. The printed circuit boards usually provided with through holes, copper circuits and copper pads of different sizes and surrounded by solder mask. In particular, a copper surfaces surrounding the holes are curved and the compression stress of the coating is predicted to be higher at these points. Whiskers growing on the coating surfaces surrounding the holes were different from those on the coatings deposited on copper pads.

The organic buffer film (OBF) (20) is coated on the surface of the substrate (10) to modify the surface of copper circuitries and protect the solder mask (10), comprises fluorocarbon-based polymers or a mixture of fluorocarbon-based polymers and conductive polymers and has a concentration, a thickness and a density. The concentration of the OBF (20) can be adjusted by mixing and diluting with ethanol and a preferred concentration of the OBF (20) is at a range of 0.1 wt % to 20 wt % and a most preferred concentration is 1 wt %. The thickness of the OBF (20) are 0.03˜3 μm.

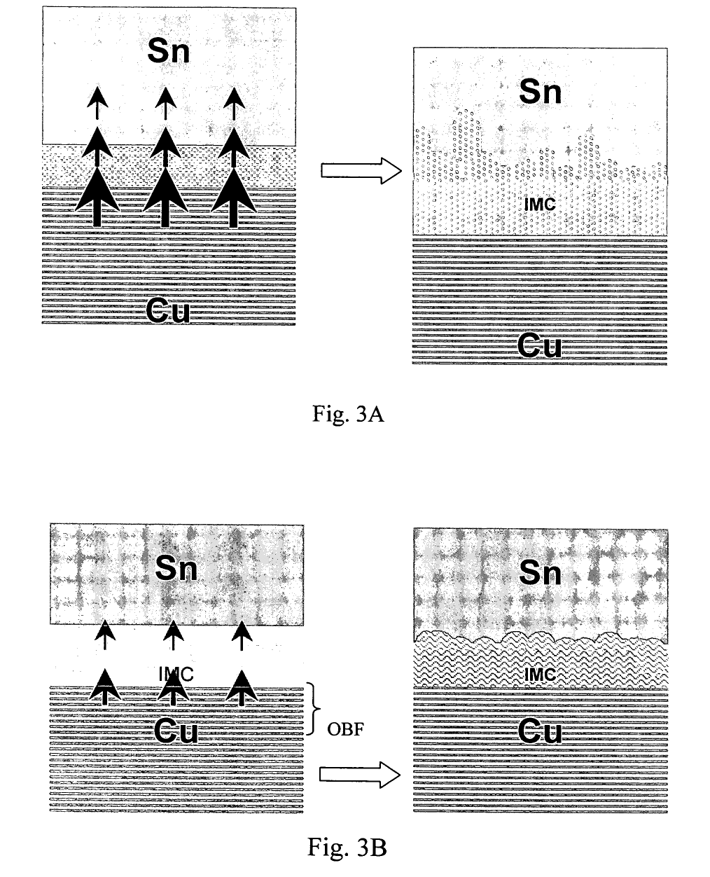

With further reference to FIG. 3, the fluorocarbon-based polymers can be adjusted by mixing and diluting with ethanol and a preferred fluorocarbon-based polymers are at a range of 0.1 wt %˜100 wt % and are commercially available as a trade name as “Nafion®” from Dupond. The Nafion® comprises a linear polymer of fluorocarbon, perfluorinated carbon segments, pending acid groups and sulfonate functional groups. The perfluorinated carbon segments may be perflourinated ion-exchange polymers to make the OBF (20) chemically and thermally stable. The sulfonate functional groups make the OBF (20) hydrophobic and insoluble in water.

The conductive polymers is electrical conductive, can be adjusted by mixing and diluting with ethanol and a preferred conductive polymers are at rage of 99.9 wt %˜0 wt % and are selected from polyaniline, poly(dibenzofuran), polyacetylene, polypyrrole, polythiophene and polyfuran.

The immersed tin layer (30) is deposited on the OBF (20) in a solution with immersed tin and has a solderability, multiple grains and an intermetallic phase (IMC). The solution may comprise: an (a) solution and a (b) solution.

Solution (a) comprises methanesulfonic acid, sodium hypophosphite, thiourea and tin methanesulfonate. The sodium hypophosphite is as a reducing agent to promote a reduction reaction. The tin methanesulfonate provides Sn²+.

Solution (b) comprises methanesulfonic acid, sodium hypophosphite, thiourea and stannous sulfate. The sodium hypophosphite is as a reducing agent to promote a reduction reaction. The stannous sulfate will be ionized and provides Sn²⁺.

A surface quality of the tin coating obtained from a stannous chloride-based immersion plating bath is easily affected by the substrate condition, and the rate of deposition is significantly slower than that for the other two systems above. Therefore, the stannous chloride-based immersion plating bath is rarely used in the electronics industry.

The IMC will be formed when copper of the substrate (10) diffuses into the immersed tin layer (30) and will be formed more slowly than it is formed in a conventional immersed tin layer because the OBF (20) is mounted between the substrate (10) and the immersed tin layer (30).

A method to form a solderable layer in accordance with the present invention comprises steps of (1) coating an organic buffer film (OBF) on a surface of a substrate to form a modified surface, (2) drying the modified surface, (3) applying the substrate into a solution with immersed tin compositions to allow the immersed tin to deposit on the OBF modified surface, (4) rinsing the modified surface with water, (5) optionally cleaning the substrate with a suitable cleaner, micro-etching the substrate with an oxidizing agent, deoxidizing with an acid and rinsing the substrate with waters, (6) drying the substrate.

Step (1) is coating an OBF on a surface of a substrate to form a modified surface. The OBF comprises 0.1 wt % to 100 wt % fluorocarbon-based polymers (solution type) and 99.9 wt % to 0 wt % conductive polymers. The substrate may be a printed circuit board (PCB). The PCB has a metal circuitry. The metal circuitry is composed of copper or copper alloys.

Step (2) is drying the modified surface at room temperature for 0 to 30 minutes.

Step (3) is applying the substrate into a solution with immersed tin in a operational temperature for a deposition time to allow the immersed tin compositions to deposit on the modified surface to form an immersed tin layer (immersed tin layer). The immersed tin deposited on the modified surface is a reduction reaction.

The solution may be a solution (a) or a solution (b). The solution (a) comprises methanesulfonic acid, sodium hypophosphite, thiourea and tin methanesulfonate. The sodium hypophosphite is as a reducing agent to accelerate the reduction reaction. The tin methanesulfonate provides Sn²⁺ after the tin methanesulfonate is ionized. The solution (b) comprises methanesulfonic acid, sodium hypophosphite, thiourea and stannous sulfate. The sodium hypophosphite is as a reducing agent to promote a reduction reaction. The stannous sulfate will be ionized and provides Sn²⁺.

The immersed tin layer is formed on the OBF and has solderability and grains.

The operational temperature is at a range of 40° C. to 90° C. to allow the immersed tin layer to have an appropriate solderability. A preferred temperature is at 70° C. If the operational temperature is lower than 45° C., the immersed tin layer will be very thin and is difficult to preserve the appropriate solderability and the grains of the immersed tin layer will be reduced. If the operational temperature is higher than 90° C., a solder mask on the substrate would be damaged.

The deposition time is between 1 to 30 minutes. A preferred deposition time is 15 minutes.Step (4) is rinsing the modified surface with water. The water is warm and has a temperature between 20˜60° C.

Step (5) is optionally cleaning the substrate with a suitable cleaner, micro-etching the substrate with an oxidizing agent, deoxidizing with an acid and rinsing the substrate with waters. The oxidizing agent is alkali metal persulfates. The acid is sulfuric acid.

Step (6) is drying the substrate at 30˜50° C. for 30 to 600 seconds.

The solderable layer can be manufactured by the method of present invention. The OBF can prevent copper of the substrate from diffusion into the immersed tin layer and inhibit the IMC from forming rapidly in the immersed tin layer. Thus, the solderable layer of the present invention has a more steady solderability than a conventional immersed tin layer without the OBF coated between the immersed tin layer and the substrate.

### EXAMPLES

The OBF make up solution was diluted to predetermined concentrations and on the substrate surfaces were maintained at 6 μl/cm². The thickness of the OBF can be calculated from the ratio and density. The thickness of a 6-μl 1 wt % OBF make up solution coated on a 1-cm² surface was calculated as 0.3 μm by using a density of 2 g/cm³ for a dry OBF. An organic buffer film (OBF) make up solution can be varied as table 1.

TABLE 1A
Component and composition of an organic buffer film (OBF)
make up solution.

| | Component | Composition (wt %) |
|---|---|---|
| OBF MA | Nafion ® | 50 |
| | PTFE | 25 |
| | Polyaniline | 25 |
| OBF MB | Nafion ® | 65 |
| | Polyaniline | 35 |
| OBF MC | Nafion ® | 100 |
| OBF MD | Nafion ® | 50 |
| | Polyfuran | 10 |
| | Poly(dibenzofuran) | 15 |
| | Polyaniline | 25 |

TABLE 1B
Component and composition of an organic buffer film (OBF)

| | Component | Composition (wt %) |
|---|---|---|
| OBF A | OBF MA | 1 |
| | Ethanol | 99 |
| OBF B | OBF MB | 1 |
| | Ethanol | 99 |
| OBF C | OBF MC | 1 |
| | Ethanol | 99 |
| OBF D | OBF MD | 1 |
| | Ethanol | 99 |
| OBF E | OBF MA | 5 |
| | Ethanol | 95 |
| OBF F | OBF MA | 10 |
| | Ethanol | 90 |

A solution with immersed tin can be varied as table 2.

TABLE 2
Components and compositions of solutions with immersed tin.

| | Component | Composition (g/l) |
|---|---|---|
| Solution A | Tin (added as stannous methane sulfonate) | 33 |
| | Methane sulfonic acid | 71.2 |
| | Thiourea | 125 |
| | Tartaric acid | 25.1 |
| | Citric acid | 350 |
| | Sodium hypophosphite | 10 |
| | Nonylphenoxypoly(ethyleneoxy)e-thanol | 2 |
| | Water | 540 |
| Solution B | Tin (added as stannous sulfate) | 37 |
| | Thiourea | 125 |
| | Sulfuric acid | 150 |
| | Citric acid | 350 |
| | Sodium hypophosphite | 10 |
| | Nonylphenoxypoly(ethyleneoxy)e-thanol | 2 |
| | Water | 540 |
| Solution C | Tin (added as stannous chloride) | 37 |
| | Hydrochloric Acid | 71.2 |
| | Thiourea | 293 |
| | Urea | 40 |
| | Sodium hypophosphite | 40 |
| | Nonylphenoxypoly(ethyleneoxy)e-thanol | 2 |
| | Water | 507 |

Using the organic buffer film (OBF) in Table 1B and the solutions with immersed tin in Table 2 to proceed following examples.

### COMPARATIVE EXAMPLE

Immersing a circuit board with copper circuitry and without pretreated by using an OBF in Solutions A, B or C for 15 minutes and at 70° C. to form a conventional immersion tin coating. Whiskers are found in less than 168 hours at room temperature especially in the area surrounding the through holes. The length of the whiskers formed on the coating surfaces obtained from plating solution A, B and C are about 2.5, 4.1 and 1.8 μm.

When the immersion tin coating formed on the PCB, irregular intermetallic compounds (IMC) generate a compressive stress in the immersion tin coating to form tin whiskers. The IMC is Sn/Cu and may be Cu₆Sn₅, Cu₃Sn or the like. Grains of the immersion tin coating also effect the IMC to form the whiskers.

The IMC originally is Cu₆Sn₅ and will be transformed to Cu₃Sn until the IMC is only consists of Cu₃Sn. Cu₃Sn can degrade the solderability of immersion tin layer.

Furthermore, stannous oxides are formed after immersion tin coating is formed. This oxide reduces the uniformity of the color of a surface of the immersion tin coating and degrades the solderability of the immersion tin coating. The immersion tin coating comprises three parts-stannous oxide, pure tin, and IMC.

### Example 1

The OBF MA was diluted with ethanol to 1% and coated on copper circuitries in circuit board to form modified surface of circuitries. Then dipped the modified circuit board in the immersion plating solution A for 15 minutes at 70° C. and an immersion tin coating was deposited on circuitries in circuit board. The immersion tin coating has a thickness of 1.7 μm. According to the scanning electronic microscope (SEM), The grains sizes of the coating surface were about 1.5˜3 μm and no whiskers were found after 240 hours storage at room temperature.

### Example 2

The OBF MA was diluted with ethanol to 5% and coated on copper circuitries in circuit board to form modified surface of circuitries. Then dipped the modified circuit board in the immersion plating solution A for 15 minutes at 70° C. and an immersion tin coating was deposited on circuitries in circuit board. The immersion tin coating has a thickness of 0.97 μm. According to the scanning electronic microscope (SEM), The grains sizes of the coating surface were about 1.7˜3.2 μm and no whiskers were found after 240 hours storage at room temperature.

### Example 3

The OBF MA was diluted with ethanol to 10% and coated on copper circuitries in circuit board to form modified surface of circuitries. Then dipped the modified circuit board in the immersion plating solution A for 15 minutes at 70° C. and an immersion tin coating was deposited on circuitries in circuit board. The immersion tin coating has a thickness of 0.52 μm. According to the scanning electronic microscope (SEM), The grains sizes of the coating surface were about 2.8˜5.3 μm and no whiskers were found after 240 hours storage at room temperature.

### Example 4

The OBF MA was diluted with ethanol to 0.5% and coated on copper circuitries in circuit board to form modified surface of circuitries. Then dipped the modified circuit board in the immersion plating solution A for 15 minutes at 70° C. and an immersion tin coating is formed and deposited on the PCB. The immersion tin coating has a thickness of 1.81 μm. According to the surface electronic microprobe (SEM), The grains sizes of the coating surface were about 0.8˜1.4 μm and some whiskers are found after 240 hours at room temperature. Comparing with Example 1, grains of the immersion tin coating in Example 4 are smaller than they are in Example 1 and a deposited rate in Example 4 is faster than it in Example 1.

Compare with Examples 1 to 4, the OBFs were coated on the surface of the substrates in different concentrations. This implies the OBFs have different thicknesses on the circuits. Higher concentration can cause thicker coating thickness of OBF. A thicker OBF layers were prepared by using higher concentrations of make up solution. The thickness of the OBF was affected by its concentration. Moreover, an immersion tin plating is a replacement reaction and plating solution must pass through the OBF layer to the circuitry surface. Therefore, thicker OBF film could reduce deposited rate of the immersion tin coating. Moreover, the thickness can produce different rates of copper diffusion. A thicker OBF is prepared on the surface of the copper substrates by spin coating twice and produces larger grains, so the solderability can be preserved for a longer time. However, the deposition time should be longer. It was also found that the grains sizes were affected by the thickness of OBFs. The thicker of OBFs cause larger grains sizes.

The grains can also affect the growth of whiskers by reducing the activation energy. A tin coating with a large grain size is thermodynamically more stable than a coating with smaller grain size, and is less susceptible to recrystallization. Moreover, at the same level of internal stress, a single-crystal whisker is less likely to originate from large and compact grains than from smaller grains. Thus, the coating surface with larger grains is preferred. The grains sizes of the deposited layers (30) can be enlarged when the OBF (20) is pre-coated onto the circuits' surfaces and it also could reduce tin whiskers formed.

### Example 5

The OBF MA was diluted with ethanol to 1% and coated on copper circuitries in circuit board to form modified surface of circuitries. Then dipped the modified circuit board in the immersion plating solution B for 15 minutes at 70° C. and an immersion tin coating is formed and deposited on the PCB. The immersion tin coating has a thickness of 1.96 μm. According to the surface electronic microprobe (SEM), no whiskers were found after 240 hours at room temperature.

### Example 6

The OBF MA was diluted with ethanol to 1% and coated on copper circuitries in circuit board to form modified surface of circuitries. Then dipped the modified circuit board in the immersion plating solution C for 15 minutes at 70° C. and an immersion tin coating is formed and deposited on the PCB. The immersion tin coating has a thickness of 0.32 μm. According to the surface electronic microprobe (SEM), no whiskers were found after 240 hours at room temperature.

Compare with Examples 1, 5 and 6, the thickness of the immersion tin coatings obtained from different plating bath were found different. Thicker coating can preserve the solderability for longer. Therefore, thicker coatings were preferred.

### Example 7

The OBF MB was diluted with ethanol to 1% and coated on copper circuitries in circuit board to form modified surface of circuitries. Then dipped the modified circuit board in the immersion plating solution A for 15 minutes at 70° C. and an immersion tin coating is formed and deposited on the PCB. The immersion tin coating has a thickness of 1.2 μm. According to the surface electronic microprobe (SEM), no whiskers were found after 240 hours at room temperature.

### Example 8

The OBF MC was diluted with ethanol to 1% and coated on copper circuitries in circuit board to form modified surface of circuitries. Then dipped the modified circuit board in the immersion plating solution A for 15 minutes at 70° C. and an immersion tin coating is formed and deposited on the PCB. The immersion tin coating has a thickness of 1.471 μm. According to the surface electronic microprobe (SEM), no whiskers were found after 240 hours at room temperature.

Compared with example 1, 7 and 8, the cost of OBF A is cheaper than B and than C.

### Example 9

The OBF MD was diluted with ethanol to 1% and coated on copper circuitries in circuit board to form modified surface of circuitries. Then dipped the modified circuit board in the immersion plating solution A for 15 minutes at 70° C. and an immersion tin coating is formed and deposited on the PCB. The immersion tin coating has a thickness of 1.34 μm. According to the surface electronic microprobe (SEM), no whiskers were found after 240 hours at room temperature.

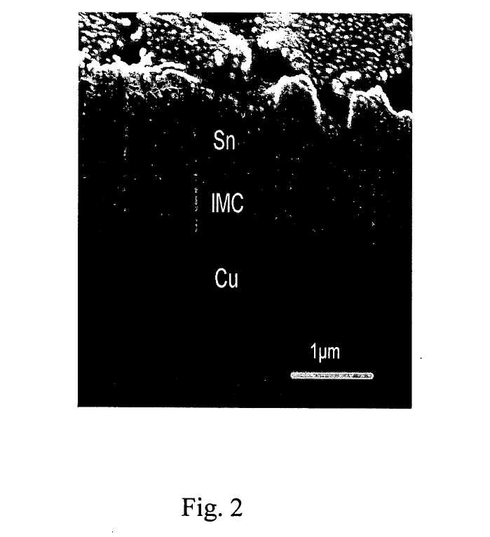

An image of the cross-sectional microstructure of the immersion-coated layer deposited on an OBF A precoated copper surface was prepared by FIB is shown in FIG. 2. The formation of IMC layer was observed grown more regular than that without OBF. This implies that deposited on an OBF precoated copper surface could reduce the irregularly grow of the IMC layer and was not affected by the roughness and smoothness of the copper surface. Moreover, the formation of compress stress could be reduced.

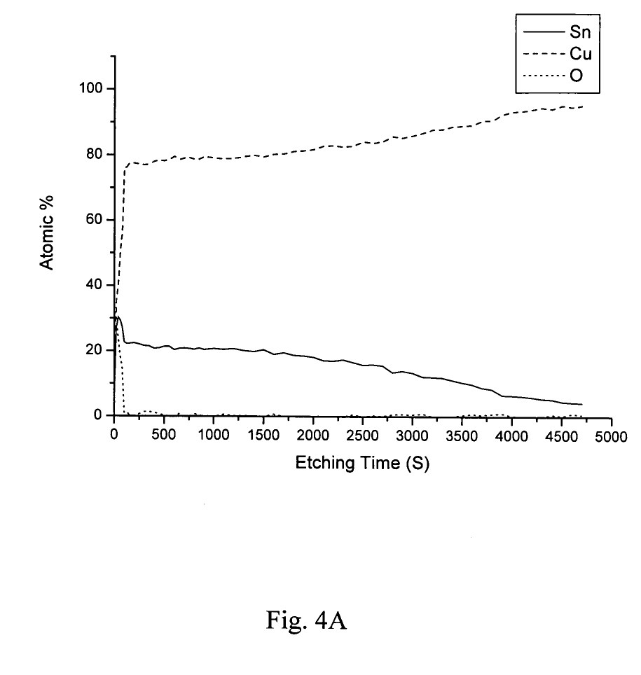

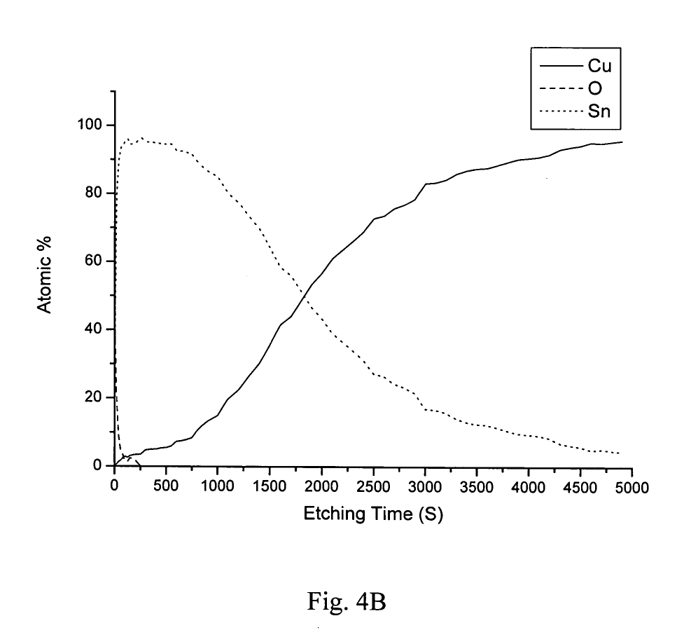

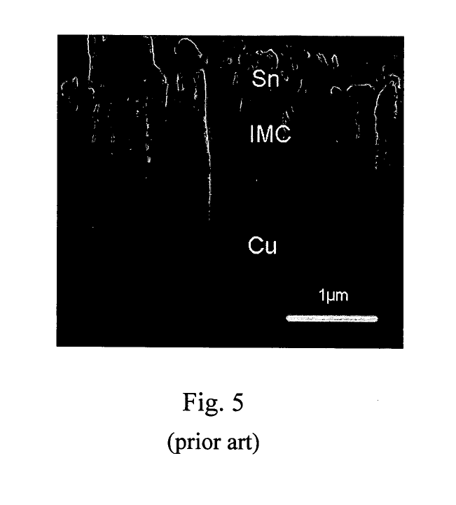

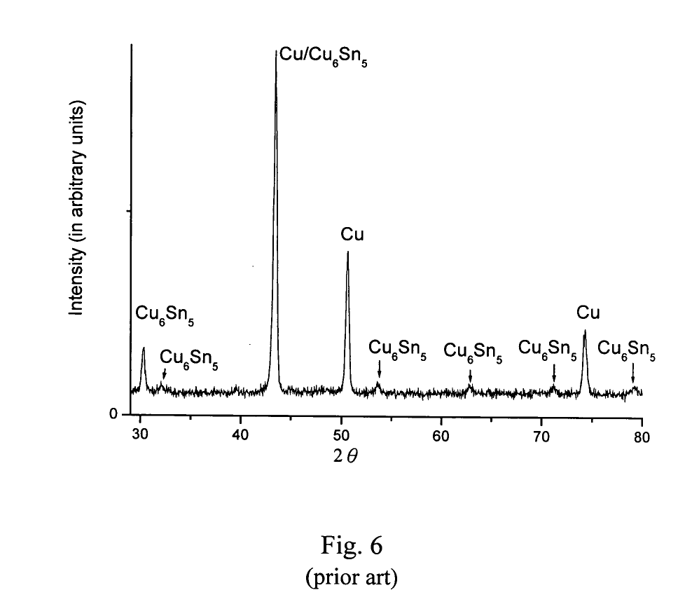

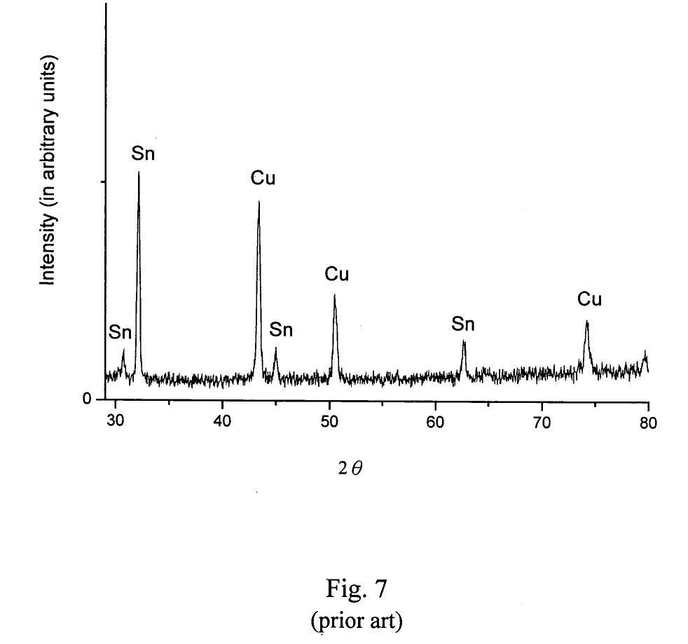

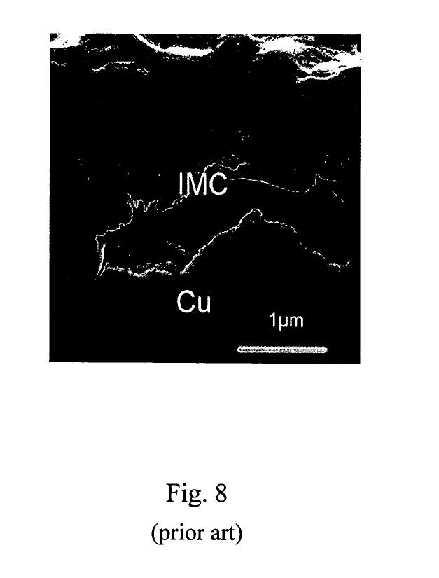

FIG. 3 was the schematic representation of immersion tin coatings deposited on copper, which was precoated an OBF. When coated onto the surface of copper substrates, OBF can reduce the diffusion of atoms. Therefore, the amount of copper diffusion into the immersion tin coating is diminished and the rate of IMC formation is reduced. This result was conformed with XPS depth profile shown in FIG. 4. FIG. 4 shows an XPS depth profile of the immersion tin coating layer deposited at 60° C. for 10 min during 90 days of storage. FIG. 8(A) shows the depth profile of the coating deposited on the copper pad without OBF precoated. In the bulk of the immersion tin coating both copper and tin were observed indicating that IMC layer was formed. FIG. 8(B) shows the depth profile of the coating deposited on the copper pad with OBF precoated. The tin-rich area containing oxygen near the surface is due to the formation of stannous oxide during storage. In the bulk of the coating, both copper and tin existed. The concentration of tin was found to decrease from the coating surface to the copper substrate and the concentration of copper was found to increase from the coating surface to the copper substrate. Therefore, the tin-rich and copper-rich environment were formed in the coating structure. The distributions of copper and tin were different that shown in FIG. 8(A). This was due to the diffusion of the metal ions, copper and tin, wwere reduced by OBF.

At the soldering temperature (generally below 230° C.), the immersion tin layer melts and forms an alloy with a molten solder, which in turn wets the substrate. If a surface of the PCB is nonwettable, the surface cannot be soldered. However, the oxides and IMC (Cu₃Sn) are nonwettable, so the conventional immersion tin coating has a reduced solderability.

The immersion tin coating of the present invention has grains with an enlarged size and a compact surface area because the OBF is mounted between the PCB and the immersion tin coating. Grains can also affect a growth of whiskers by reducing activation energy of the whisker. An immersion tin coating with a large grain size is thermodynamically more stable and less susceptible to recrystallization than it with smaller grain sizes. Moreover, whiskers are more difficult to squeeze out and grow from large grains than from smaller grains, so an immersion tin coating with larger grains should be better. The grains of the immersion tin coating of the present invention will reduce formations of oxides, IMC and whiskers to preserve the solderability of the immersion tin coating for a longer time.

What is claimed is:

1. A solderable layer having
a substrate;
an organic buffer film (OBF) coated on the surface of the substrate and comprising fluorocarbon-based polymers; and
an immersed tin layer deposited on the OBF on the substrate.

2. The solderable layer as claimed in claim 1, wherein the substrate is circuitries on a printed circuit board (PCB).

3. The solderable layer as claimed in claim 1, wherein the organic buffer film (OBF) comprises:
fluorocarbon-based polymers being at a range of 0.1 wt % to 100 wt %; and
conductive polymers being at a range of 99.9 wt %˜0 wt %.

4. The solderable layer as claimed in claim 1, wherein the organic buffer film (OBF) has a concentration adjusted by mixing and diluted with ethanol and being at a range of 0.1 wt % to 20 wt %.

5. The solderable layer as claimed in claim 1, wherein the organic buffer film (OBF) has a concentration adjusted by mixing and diluted with ethanol and being at a range of 1 wt %.

6. The solderable layer as claimed in claim 1, wherein the organic buffer film (OBF) has a thickness being 0.03˜3 μm.

7. The solderable layer as claimed claim 2, wherein the PCB has
a surface; and
a metal circuitry mounted on the surface of the PCB surrounded by solder mask and be composed of copper or copper alloys.

8. The solderable layer as claimed in claim 3, wherein the fluorocarbon-based polymers comprises a linear polymer of fluorocarbon, perfluorinated carbon segments, pending acid groups and sulfonate functional groups.

9. The solderable layer as claimed in claim 3, wherein the conductive polymers are selected from polyaniline, poly(dibenzofuran), polyacetylene, polypyrrole, polythiophene and polyfuran.

10. A method to manufacture the solderable layer according to any one of claims 1 to 10 has following steps:
(1) coating an organic buffer film (OBF) on a surface of a substrate to form a modified surface;
(2) drying the modified surface;
(3) applying the substrate into a solution with immersed tin compositions to allow the immersed tin coating to deposit on the modified surface;
(4) rinsing the modified surface with water; and
(5) drying the substrate.

11. The solderable layer as claimed in claim 10, wherein the solution of step (3) comprises methanesulfonic acid, sodium hypophosphite, thiourea and tin methanesulfonate.

12. The solderable layer as claimed in claim 10, wherein the solution of step (3) comprises methanesulfonic acid, sodium hypophosphite, thiourea and stannous sulfate.

13. The method to manufacture the solderable layer as claimed in claim 10 further comprising cleaning the substrate with a suitable cleaner, micro-etching the substrate with an oxidizing agent, deoxidizing with an acid and rinsing the substrate with waters after step (4) and before step (5).

14. The method to manufacture the solderable layer as claimed in claim 10, wherein the operational temperature in step (3) is at a range of 40° C. to 90° C.

15. The method to manufacture the solderable layer as claimed in claim 10, wherein an operational temperature in step (3) is at 70° C.

16. The method to manufacture the solderable layer as claimed in claim 10, wherein a deposition time in step (3) is between 1 to 30 minutes.

17. The method to manufacture the solderable layer as claimed claim 10, wherein a deposition time in step (3) is 15 minutes.

18. The method to manufacture the solderable layer as claimed claim 10, wherein water of step (4) has a temperature between 20˜60° C.

19. The method to manufacture the solderable layer as claimed claim 10, wherein step (5) is drying the substrate at 30˜50° C. for 30 to 600 seconds.
